(19) United States
(12) Patent Application Publication
(10) Pub. No.: US 2014/0258089 A1
(43) Pub. Date: Sep. 11, 2014

(54) ESTIMATED SCORE STABILITY SYSTEM

(71) Applicant: Experian Information Solutions, Inc., Costa Mesa, CA (US)

(72) Inventors: Michele Marie Pearson, Irvine, CA (US); Gregor R. Bonin, San Diego, CA (US); Honghao Shan, San Diego, CA (US)

(21) Appl. No.: 13/794,288

(22) Filed: Mar. 11, 2013

(51) Int. Cl. G06Q 40/02

(52) U.S. Cl. CPC G06Q 40/025
USPC 705/38

(57) ABSTRACT

In one embodiment, an estimated score stability system provides an approximation of a customer's historical credit scores based on trended data. These estimated credit scores can then be used to track information about a consumer over time.

### BACKGROUND

Credit bureau data includes information collected from various sources and can be used to helping entities such as lenders and/or credit card issuers improve the effectiveness of safe and sound lending. Traditional credit bureau data provides a view into a consumer's most recent information and does not provide historical information or track a consumer's change in risk over time. Accordingly, a more complete estimated historical picture of a consumer's information would be beneficial to lenders and/or credit card issuers to further improve the effectiveness of safe and sound lending.

### SUMMARY OF THE DISCLOSURE

In one embodiment, an estimated score stability system provides an approximation of a customer's historical credit scores based on trended data. These estimated credit scores can then be used to track information about a consumer over time.

In one embodiment, a computer-implemented method of generating estimated credit scores is provided. The method may include accessing, by a computing system, trended data related to at least one consumer; excluding restricted data from the trended data; for a first time period, determining, by a computing system, a first set of attribute values by applying a first set of attributes to a first subset of the trended data that represents the at least one consumer's profile for the first time period; computing a first estimated credit score based on the first set of attribute values; and outputting the first estimated credit score. In addition, the computer-implemented method may also include for a second time period, determining, by a computing system, a second set of attribute values by applying a second set of attributes to a second subset of the trended data that represents the at least one consumer's profile for the second time period; computing a second estimated credit score based on the second set of attribute values; and outputting the second estimated credit score. Furthermore, the trended data may include balance limit and payment history for a plurality of consumers' trades; the first estimated credit score may represent the consumer's risk profile for the first time period; the first estimated credit score and the second estimated credit score may represent the consumer's estimated risk profile for the first time period and the second time period; the first estimated credit score may represent the consumer's propensity to open new accounts for the first time period; and/or the first estimated credit score may represent the consumer's propensity to apply for credit for the first time period. Moreover, the computer-implemented method may also include analyzing the first estimated credit score and the second estimated credit score to determine correlations with events. In addition, the events may include at least one of a life style change, a change in purchasing power, or a change in risk; and/or the at least one consumer may include thousands of consumers. In addition, the computer-implemented method may also include for a predetermined number of time periods, determining, by a computing system, a set of attribute values for each of the predetermined number of time periods by applying a number of attributes to a subset of the trended data that represents the at least one consumer's profile for the predetermined number of time periods; computing estimated credit scores based on the set of attribute values for each of the predetermined number of time periods; and outputting the estimated credit scores for each of the predetermined number of time periods.

In a further embodiment, a non-transitory computer storage having stored thereon a computer program that instructs a computer system is provided. The computer program that instructs the computer system may at least: access trended data related to at least one consumer; exclude restricted data from the trended data; for a first time period, determine a first set of attribute values by applying a first set of attributes to a first subset of the trended data that represents the at least one consumer's profile for the first time period; compute a first estimated credit score based on the first set of attribute values; and output the first estimated credit score. In addition, the computer program that instructs the computer system may also for a second time period, determine a second set of attribute values by applying a second set of attributes to a second subset of the trended data that represents the at least one consumer's profile for the second time period; compute a second estimated credit score based on the second set of attribute values; and output the second estimated credit score. Furthermore, the trended data may include balance limit and payment history for a plurality of consumers' trades; the first estimated credit score may represent the consumer's risk profile for the first time period; the first estimated credit score and the second estimated credit score may represent the consumer's estimated risk profile for the first time period and the second time period; the first estimated credit score may represent the consumer's propensity to open new accounts for the first time period; and/or the first estimated credit score may represent the consumer's propensity to apply for credit for the first time period. Moreover, the computer program that instructs the computer system may also analyze the first estimated credit score and the second estimated credit score to determine correlations with events. In addition, the events may include at least one of a life style change, a change in purchasing power, or a change in risk and/or the at least one consumer may include thousands of consumers. In addition, the computer program that instructs the computer system may also for a predetermined number of time periods, determine a set of attribute values for each of the predetermined number of time periods by applying a number of attributes to a subset of the trended data that represents the at least one consumer's profile for the predetermined number of time periods; compute estimated credit scores based on the set of attribute values for each of the predetermined number of time periods; and output the estimated credit scores for each of the predetermined number of time periods.

In an addition embodiment, a system for generating estimated credit scores is provided. The system may include a first physical data store configured to store trended data; and a computing device in communication with the first physical data store and configured to access trended data related to at least one consumer, exclude restricted data from the trended data, for a first time period, determine a first set of attribute values by applying a first set of attributes to a first subset of the trended data that represents the at least one consumer's profile for the first time period, compute a first estimated credit score based on the first set of attribute values, and output the first estimated credit score. In addition, the system computing device may be further configured to for a second time period, determine a second set of attribute values by applying a second set of attributes to a second subset of the trended data that represents the at least one consumer's profile for the second time period; compute a second estimated credit score based on the second set of attribute values; and output the second estimated credit score. Furthermore, the trended data may include balance limit and payment history for a plurality of consumers' trades. Moreover, the first estimated credit score may represent the consumer's risk profile for the first time period; the first estimated credit score and the second estimated credit score may represent the consumer's estimated risk profile for the first time period and the second time period; the first estimated credit score may represent the consumer's propensity to open new accounts for the first time period; and/or the first estimated credit score may represent the consumer's propensity to apply for credit for the first time period. In addition, the system computing device may be further configured to analyze the first estimated credit score and the second estimated credit score to determine correlations with events. Furthermore, the events may include at least one of a life style change, a change in purchasing power, or a change in risk; and/or the at least one consumer may include thousands of consumers. In addition, the system computing device may be further configured to for a predetermined number of time periods, determine a set of attribute values for each of the predetermined number of time periods by applying a number of attributes to a subset of the trended data that represents the at least one consumer's profile for the predetermined number of time periods; compute estimated credit scores based on the set of attribute values for each of the predetermined number of time periods; and output the estimated credit scores for each of the predetermined number of time periods.

### BRIEF DESCRIPTION OF THE DRAWINGS

FIG. 1 is a block diagram showing one embodiment of an estimated score stability system.

FIG. 2 is a flow chart illustrating one embodiment of an estimated score stability system.

FIG. 3 is a diagram showing one embodiment of example formulas for calculating estimated credit scores over time.

FIG. 4 is one embodiment of an example calculation of estimated credit scores based on a set of attributes.

### DETAILED DESCRIPTION

In one embodiment, an estimated score stability system provides an approximation of a customer's historical credit scores based on trended data. These estimated credit scores, also referred to as “pseudo scores” or “synthetic scores” can then be used by the estimated score stability system to track information about a consumer over time, such as, for example, tracking risk, an indication of the consumer's purchasing power, the likelihood the consumer will open a new account, and so forth. For tracking risk, this information can allow lenders or other entities to assess whether or not a consumer has displayed a stable risk profile or whether the consumer's risk profile is likely to change over time. As one example, a lending institution may be deciding whether to offer credit to a consumer whose current credit score is 720. The lending institution may decide not to offer credit if it learns that in the last year, the consumer's estimated credit scores hovered closer to 790 and in the last few months the estimated credit scores showed a significant drop. On the other hand, the lending institution may decide to offer credit if it learns that in the last year, the consumer's estimated credit scores started at 700 and have been slowly increasing at a steady rate. An estimated score stability system could also be used for predictions other than risk, such as, for example, to predict a consumer's propensity to open a new account, to refinance a loan, to change spend, and so forth. As one example, an estimated score stability system could be used to build a series of scores to track a consumer's propensity for opening a new account over time.

In some embodiments, the trended data includes a consumer's lending and balance information over an extended period of time. For example, the trended data may include a consumer's balances, limits, and payment history for each of their trades over a 24 month period. In one embodiment, portions of the trended data may be used to calculate financial, risk, or other attributes. For example, balance data may be used to calculate a consumer's mean balance attribute in a particular month. In some embodiments, several months of estimated trended data may be used to calculate an attribute for a given month. For example, six months of trended data may be used to calculate the number of trades that are more than 90 days delinquent in the last six months. The estimated score stability system may store and utilize a set of attributes for each month which are deemed to be useful in predicting certain behavior, such as in predicting a consumer's credit risk. In some embodiments, a monthly risk score representing the consumer's credit risk for a particular month may be calculated from the set of attributes that correspond to that month.

In one embodiment, the estimated score stability information may be provided on a credit profile report and/or estimated score stability report to a lending institution or other entity. In another embodiment, the estimated score stability information may be provided on a credit profile report and/or estimated score stability report to an individual customer.

As used herein, the terms “individual” and/or “consumer” may be used interchangeably, and should be interpreted to include applicants, customers, single individuals as well as groups of individuals, such as, for example, families, married couples or domestic partners, and business entities.

More particularly, the terms “individual” and/or “consumer” may refer to: an individual subject of the estimated score stability system (for example, an individual person whose credit bureau data is being complied and estimated score stability is being estimated). The terms “customer” and/or “client” may refer to: a large receiver or purchaser of the estimated score stability information that is produced by the estimated score stability system (for example, a lender that is receiving a credit profile report on an individual, including estimated score stability that the individual may produce for the lender); and/or a small (or individual) receiver or purchaser of the estimated score stability information that is produced by the estimated score stability system (for example, an individual person that is receiving a credit profile report on themselves, including estimated score stability that the individual may produce for a lender).

In general, however, for the sake of clarity, the present disclosure usually uses the term “consumer” to refer to an individual subject of the estimated score stability system, the term “customer” to refer to a small (or individual) receiver or purchaser of the estimated score stability information that is produced by the estimated score stability system, and the term “client” to refer to a large receiver or purchaser of the estimated score stability information that is produced by the estimated score stability system.

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of which is solely responsible for its desirable attributes or which is essential to practicing the embodiments of the disclosure herein described.

### Estimated Score Stability System

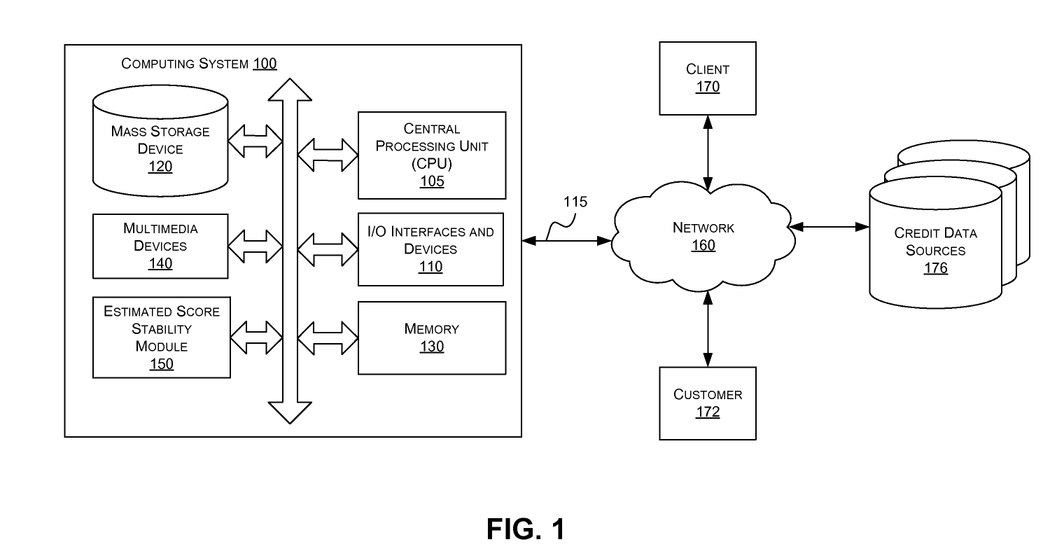

FIG. 1 is a block diagram showing one embodiment of an estimated score stability system. The estimated score stability system includes an estimated score stability computing system 100 (or simply “computing system 100”), a communication link 115, a network 160, a client system 170, a customer system 172, and credit data sources 176. Additionally, the computing system 100 includes a central processing unit (CPU) 105, input/output (I/O) interfaces and devices 110, a mass storage device 120, a memory 130, multimedia devices 140, and an estimated score stability module 150.

In the estimated score stability system of FIG. 1, the computing system 100 is in communication with the network 160, and the client system 170, the customer system 172, and the credit data sources 176 are also in communication with the network 160. The communication link 115 is the communications link between the various components of the estimated score stability system and the network 160. The computing system 100 may be used to implement systems and methods described herein.

### Estimation Method

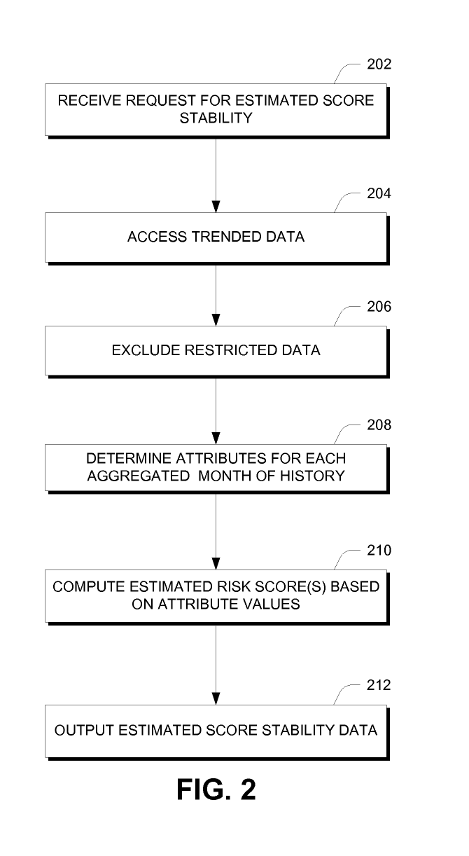

FIG. 2 is a flow chart illustrating one embodiment of a method of estimating the estimated score stability of a consumer. The method may be stored as a process accessible by the estimated score stability module 150 and/or other components of the computing system 100. Depending on the embodiment, certain of the blocks described below may be removed, others may be added, and the sequence of the blocks may be altered.

Beginning in block 202, a request for an estimated score stability analysis is received by the estimated score stability module 150. The request for estimated score stability analysis may come from a client system 170, a customer system 172, or a module within the computing system. The request may include, for example, an identification of a specific consumer, a group of consumers, and/or a population of consumers designated by, for example, an identifier. The type of request received may also indicate the preferred final output of the estimated score stability analysis. For example, a request for estimated score stability of a specific consumer may produce a report on that specific consumer, while a request for an estimated score stability of a group of consumers may produce a report on the combined group of consumers. Alternatively, the request for estimated score stability may explicitly specify the type of analysis desired. For example, the request for estimated score stability on a group of consumers may explicitly specify that individual reports on a per-consumer basis are desired.

In block 204, the estimated score stability system 100 accesses trended data from the credit data sources 176 (for example, trended data that is relevant to the estimated score stability request received). Typically, the estimated score stability module 150 accesses the credit data sources 176 over the network 160 to retrieve the trended data. However, in other embodiments, one or more of the credit data sources 176 are stored in the estimated score stability system 100 and/or are in direct communication with the estimated score stability system 100. In some embodiments, the trended data may include TrendView^{SM} data or data from another credit bureau or credit data source. In one embodiment, the trended data includes information from more than one month. In some embodiments, the trended data may include information from up to 6 months, up to 12 months, up to 18 months, up to 24 months, up to 30 months, up to 36 months, up to 48 months, up to 60 months, up to 72 months, or more.

In one embodiment, the credit data sources 176 may include other types of data such as, for example, transaction data, such as credit card transaction data. The use of additional data types may be used in generating the estimated scores. Furthermore, greater accuracy may be achieved with the addition of additional data types.

In block 206, restricted data is excluded. Restricted data may include any type of data that will not be used by the estimated score stability system to generate the estimated scores. For example, under the Federal Credit Reform Act, negative information may only be used for a period of seven years. Thus, negative information that is older than seven years is excluded. Other types of data may be excluded from the estimated score stability system for other reasons.

In block 208, attributes values are determined for each aggregated month of history based on the portions of the non-excluded trended data. Any number of attributes which are helpful in estimating estimated score stability may be used. Examples of attributes (which are calculated from trended data) may include, but are not limited to: number of trades, monthly utilization of trades, monthly balance of trades, monthly credit limits of trades, number of accounts more than X days past due in the last Y months, time since an account was more than X days past due, and so forth. As is apparent from these examples, some attributes require multiple prior months of data to calculate the attribute value for a given month. Thus, in some circumstances, attributes are calculated for less than the total months of trended data. For example, an attribute which requires six months of data may be calculated for the last 18 months if 24 months of trended data are available, but not for the first 6 months.

In block 210, estimated risk score(s) are calculated based on the attribute values for a given time period. For example, an estimated risk score for each month may be calculated using the corresponding set of attributes applied to the non-restricted, trended data for that month as determined in block 208. Different importance values or weights may be assigned to each attribute in the set. The attribute values may then be combined or summed and/or and offset value may be added to the totals to arrive at a specific score. Additional data may also be added to supplement the attributes in determining the estimated risk score(s).

In some embodiments, estimated risk score(s) may be provided for a time period other than monthly. For example, estimated risk score(s) may be calculated on a quarterly, semi-annual, or annual basis. In addition, summaries of the estimated risk score(s) may be provided, such as, for example a value representing three months of scores, 6 months of scores, and so forth. In other embodiments, summaries may be provided that report time periods with large or statistically significant changes in the estimated scores.

In block 212, estimated score stability data, which includes the generated estimated risk score(s), is output. The estimated score stability data may be output in the form of an electronic or hard copy report to a client or customer. In other embodiments, the estimated score stability data may be provided for display in a user interface and/or directly fed into a module of another system. The estimated score stability data may be provided to clients or customers such as companies that make lending and underwriting decisions such as credit cards, banks, credit unions, auto financing companies, savings and loan companies, and/or mortgage and financing companies; and/or individual customers, such as individual persons.

In one embodiment, the method of estimating the estimated score stability of a consumer is performed by a credit bureau system. Alternatively, the estimated score stability information may be performed by another entity's system.

In some embodiments, the estimated score stability data may be calculated for an individual consumer. In other embodiments, the estimated score stability data may be calculated for more than one consumer. For example, the estimated score stability data may be calculated for hundreds of consumers, thousands of consumers, tens-of-thousands of consumers, or more.

### Example Uses of Some Embodiments

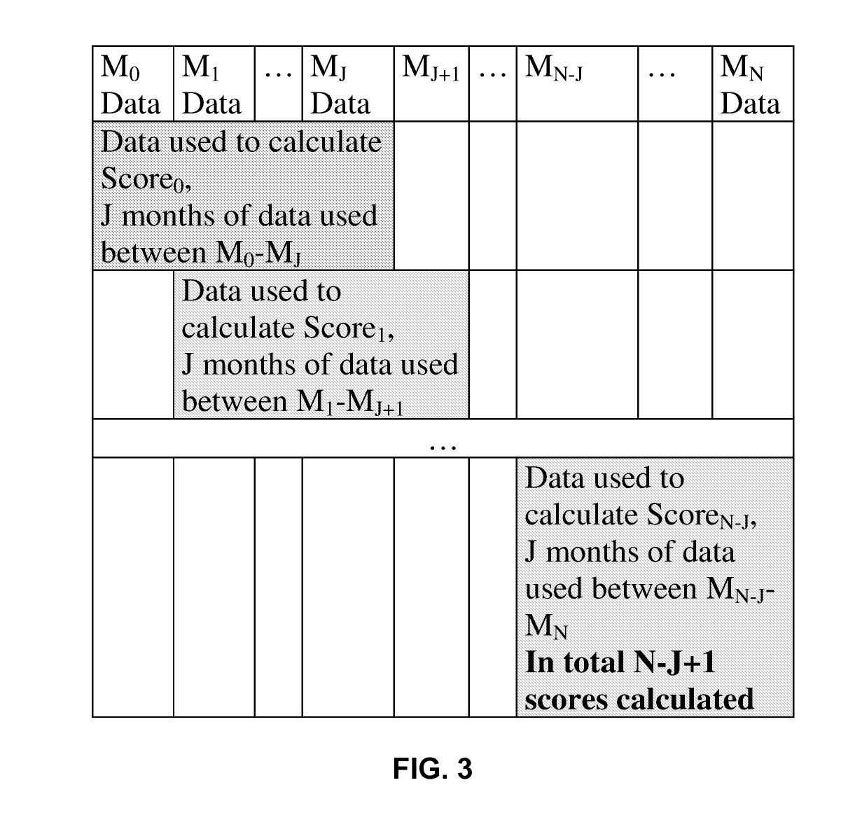

FIG. 3 is a diagram showing one embodiment of example time-sliding windows for calculating estimated credit scores over time. A first estimated credit score (Score₀) may be calculated using J months of data between M₀ and M_{J}. A second estimated credit score (Score1) may be calculated using J months of data between M₁ and M_{J+1}. Any number of additional estimated credit scores may be calculated such that the total number of estimated credit scores is equal to N-J+1 and the last estimated credit score (Score_{N-J}) may be calculated using J months of data between M_{N-J} and M_{N}. In one embodiment, M₀ is the more recent month and M_{J} is the later month. In addition, there is not a score for the last months because J months of data is required, and for the last months, there is not enough data to generate the score.

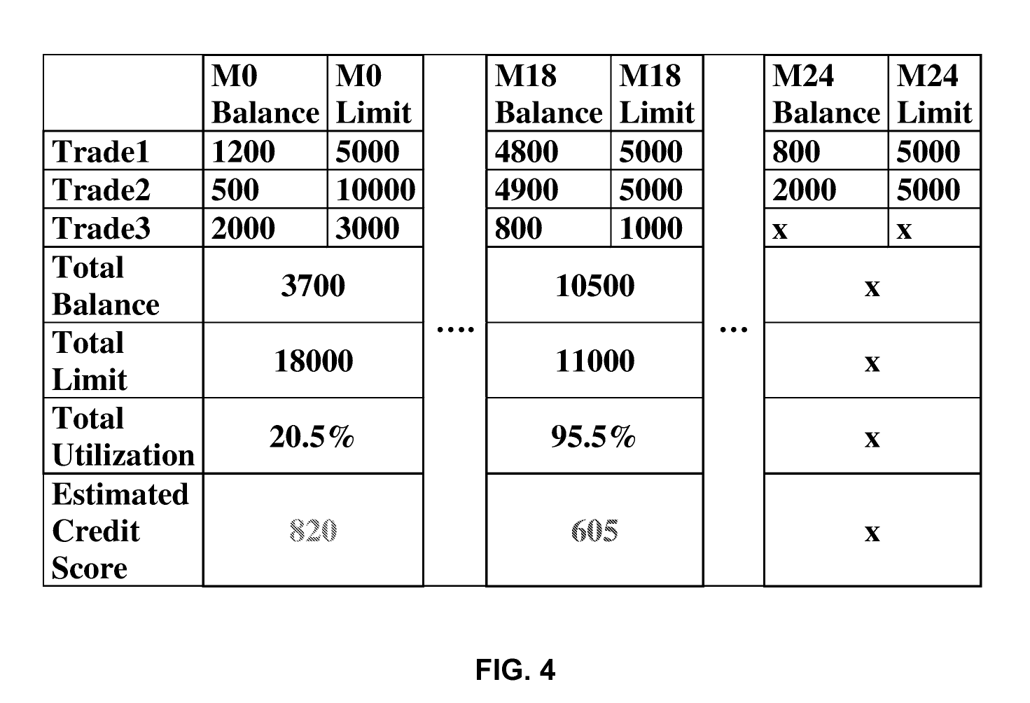

FIG. 4 is showing one embodiment of example sets of monthly data for calculating estimated credit scores based on a set of attributes using the time-sliding windows described in FIG. 3. In this example, N is equal to 24 and J is equal to 6 and 19 estimated scores are calculated based on data from M₀ to M₂₄. For M₀ (example January 2012) the Total Balance is $3,700 and the Total Limit is $18,000 based on Trade1, Trade2, and Trade3. Using this information, the Total Utilization can be calculated by dividing the Total Balance by the Total Limit, which is 20.5%. The Estimated Credit Score can be generated, using one or more of the information from Trade1, Trade2, and Trade3, the Total Balance, the Total Limit, and/or the Total Utilization, which in this example is 820. A similar estimated credit score can be generated for each previous month through M₁₈ (example July 2010). In this embodiment, however, estimated credit scores are not generated for M₁₉ and M₂₄ since there are not enough months of historical data.

Traditional credit score products are usually limited to current information for practical and legal reasons. The limited data from such a fixed time period may make it difficult to make predictions or manage accounts in certain situations. For example, some consumer's credit risk may not change significantly from month-to-month while others may oscillate greatly. By contrast, the estimated score stability systems described herein allow clients and customers to get a better sense of how a consumer's behavior, such as risk, can change over time due.

The estimated score stability systems described herein can be used to develop models to generate estimated scores. In one embodiment, non-restricted trended data may be compiled for a large number of consumers and analyzed to determine which attributes are indicative of changes in risk, changes in purchasing power, changes in lifestyle, or other interesting changes. The information may also be used to predict whether a consumer's risk is likely to increase or decrease based on certain factors. Such trends may be identified solely based on the trended data or by combining the trended data with data known from other sources. For example, certain life choices may correlate to a corresponding change in risk or purchasing power. In some embodiments, trends that are identified and correlated may be used to build models to predict similar events and/or to manage accounts. For example, it may be shown that a change in marital status may result in a corresponding change in purchasing power over a subsequent time period. Clients and customers may use such trends for account management and soliciting consumers which have been flagged as likely exhibiting an increase in purchasing power and/or a decrease in risk.

Estimated score stability data can also be used in lending and credit decisions for an individual consumer. For example, clients may classify a consumer as having a different risk than indicated by a more traditional credit score analysis if their estimated risk score(s) oscillate greatly from month-to-month. Likewise, a consumer with stable estimated risk score(s) may be classified as having a different risk than indicated by a more traditional credit score analysis. In some embodiments, the change in estimated risk score(s) may be used to supplement a traditional credit score analysis.

### Computing System

The computing system 100 includes computing devices, for example, a personal computer that is IBM, Macintosh, or Linux/Unix compatible or a server or workstation. In one embodiment, the computing system 100 comprises a server, a laptop computer, a smart phone, a personal digital assistant, a kiosk, or an media player, for example. In one embodiment, the exemplary computing system 100 includes one or more CPU 105, which may each include a conventional or proprietary microprocessor. The computing system 100 further includes one or more memory 130, such as random access memory (“RAM”) for temporary storage of information, one or more read only memory (“ROM”) for permanent storage of information, and one or more mass storage device 120, such as a hard drive, diskette, solid state drive, or optical media storage device. Typically, the modules of the computing system 100 are connected to the computer using a standard based bus system. In different embodiments, the standard based bus system could be implemented in Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of computing system 100 may be combined into fewer components and modules or further separated into additional components and modules.

The computing system 100 is generally controlled and coordinated by operating system software, such as Windows XP, Windows Vista, Windows 7, Windows 8, Windows Server, Unix, Linux, SunOS, Solaris, iOS, Blackberry OS, Android, or other compatible operating systems. In Macintosh systems, the operating system may be any available operating system, such as MAC OS X. In other embodiments, the computing system 100 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary computing system 100 may include one or more commonly available I/O interfaces and devices 110, such as a keyboard, mouse, touchpad, and printer. In one embodiment, the I/O interfaces and devices 110 include one or more display devices, such as a monitor, that allows the visual presentation of data to a user. More particularly, a display device provides for the presentation of GUIs, application software data, and multimedia presentations, for example. The computing system 100 may also include one or more multimedia devices 140, such as speakers, video cards, graphics accelerators, and microphones, for example.

In the embodiment of the estimated score stability system of FIG. 1, the I/O interfaces and devices 110 provide a communication interface to various external devices. In the embodiment of FIG. 1, the computing system 100 is electronically coupled to a network 160, which comprises one or more of a LAN, WAN, and/or the Internet, for example, via a wired, wireless, or combination of wired and wireless, communication link 115. The network 160 communicates with various computing devices and/or other electronic devices via wired or wireless communication links.

According to FIG. 1, in some embodiments information may be provided to the computing system 100 over the network 160 from one or more credit data sources 176. The credit data sources 176 may include one or more internal and/or external databases, data sources, and physical data stores. The credit data sources 176 may include internal and external data sources which store, for example, credit bureau data (for example, credit bureau data from File One^{SM}, include, for example, balances on lines of credit, and/or delinquency, among other things) and/or historical trade data (for example, data from TrendView^{SM}), among other things. In some embodiments, one or more of the databases or data sources may be implemented using a relational database, such as Sybase, Oracle, CodeBase, and Microsoft® SQL Server, as well as other types of databases such as, for example, a flat file database, an entity-relationship database, and object-oriented database, and/or a record-based database.

In the embodiment of FIG. 1, the computing system 100 includes the estimated score stability module 150 that may be stored in the mass storage device 120 as executable software codes that are executed by the CPU 105. These modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 1, the computing system 100 is configured to execute the estimated score stability module 150 in order to generate, for example, estimated scores.

In general, the word “module,” as used herein, refers to logic embodied in hardware or firmware, or to a collection of software instructions, possibly having entry and exit points, written in a programming language, such as, for example, Java, Lua, C and/or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the computing system 100, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

### Additional Embodiments

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the category spend computing system 100 and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A computer-implemented method of generating estimated credit scores, the method comprising:
accessing, by a computing system, trended data related to at least one consumer;
excluding restricted data from the trended data;
for a first time period, determining, by a computing system, a first set of attribute values by applying a first set of attributes to a first subset of the trended data that represents the at least one consumer's profile for the first time period;
computing a first estimated credit score based on the first set of attribute values; and
outputting the first estimated credit score.

2. The computer-implemented method of claim 1, further comprising:
for a second time period, determining, by a computing system, a second set of attribute values by applying a second set of attributes to a second subset of the trended data that represents the at least one consumer's profile for the second time period;
computing a second estimated credit score based on the second set of attribute values; and
outputting the second estimated credit score.

3. The computer-implemented method of claim 1, wherein the trended data includes balance limit and payment history for a plurality of consumers' trades.

4. The computer-implemented method of claim 1, wherein the first estimated credit score represents the consumer's risk profile for the first time period.

5. The computer-implemented method of claim 2, wherein the first estimated credit score and the second estimated credit score represents the consumer's estimated risk profile for the first time period and the second time period.

6. The computer-implemented method of claim 1, wherein the first estimated credit score represents at least one of: the consumer's propensity to open new accounts for the first time period or the consumer's propensity to apply for credit for the first time period.

7. The computer-implemented method of claim 2, further comprising analyzing the first estimated credit score and the second estimated credit score to determine correlations with events.

8. The computer-implemented method of claim 7, wherein the events include at least one of a life style change, a change in purchasing power, or a change in risk.

9. The computer-implemented method of claim 7, wherein the at least one consumer includes thousands of consumers.

10. The computer-implemented method of claim 1, further comprising:
for a predetermined number of time periods,
determining, by a computing system, a set of attribute values for each of the predetermined number of time periods by applying a number of attributes to a subset of the trended data that represents the at least one consumer's profile for the predetermined number of time periods;
computing estimated credit scores based on the set of attribute values for each of the predetermined number of time periods; and
outputting the estimated credit scores for each of the predetermined number of time periods.

11. Non-transitory computer storage having stored thereon a computer program that instructs a computer system by at least:
accessing trended data related to at least one consumer;
excluding restricted data from the trended data;
for a first time period, determining a first set of attribute values by applying a first set of attributes to a first subset of the trended data that represents the at least one consumer's profile for the first time period;
computing a first estimated credit score based on the first set of attribute values; and
outputting the first estimated credit score.

12. The non-transitory computer storage of claim 11, further comprising:
for a second time period, determining a second set of attribute values by applying a second set of attributes to a second subset of the trended data that represents the at least one consumer's profile for the second time period;
computing a second estimated credit score based on the second set of attribute values; and
outputting the second estimated credit score.

13. The non-transitory computer storage of claim 11, wherein the trended data includes balance limit and payment history for a plurality of consumers' trades.

14. The non-transitory computer storage of claim 11, wherein the first estimated credit score represents the consumer's risk profile for the first time period.

15. The non-transitory computer storage of claim 12, wherein the first estimated credit score and the second estimated credit score represents the consumer's estimated risk profile for the first time period and the second time period.

16. The non-transitory computer storage of claim 11, wherein the first estimated credit score represents at least one of: the consumer's propensity to open new accounts for the first time period or the consumer's propensity to apply for credit for the first time period.

17. The non-transitory computer storage of claim 12, further comprising analyzing the first estimated credit score and the second estimated credit score to determine correlations with events.

18. The non-transitory computer storage of claim 17, wherein the events include at least one of a life style change, a change in purchasing power, or a change in risk.

19. The non-transitory computer storage of claim 17, wherein the at least one consumer includes thousands of consumers.

20. The non-transitory computer storage of claim 11, further comprising:
for a predetermined number of time periods, determining a set of attribute values for each of the predetermined number of time periods by applying a number of attributes to a subset of the trended data that represents the at least one consumer's profile for the predetermined number of time periods;
computing estimated credit scores based on the set of attribute values for each of the predetermined number of time periods; and
outputting the estimated credit scores for each of the predetermined number of time periods.

21. A system for generating estimated credit scores, the system comprising:
a first physical data store configured to store trended data; and
a computing device in communication with the first physical data store and configured to:
access trended data related to at least one consumer;
exclude restricted data from the trended data;
for a first time period, determine a first set of attribute values by applying a first set of attributes to a first subset of the trended data that represents the at least one consumer's profile for the first time period;
compute a first estimated credit score based on the first set of attribute values; and
output the first estimated credit score.

22. The system of claim 21, the computing device further configured to:
for a second time period, determine a second set of attribute values by applying a second set of attributes to a second subset of the trended data that represents the at least one consumer's profile for the second time period;
compute a second estimated credit score based on the second set of attribute values; and
output the second estimated credit score.

23. The system of claim 21, wherein the trended data includes balance limit and payment history for a plurality of consumers' trades.

24. The system of claim 21, wherein the first estimated credit score represents the consumer's risk profile for the first time period.

25. The system of claim 22, wherein the first estimated credit score and the second estimated credit score represents the consumer's estimated risk profile for the first time period and the second time period.

26. The system of claim 21, wherein the first estimated credit score represents at least one of: the consumer's propensity to open new accounts for the first time period or the consumer's propensity to apply for credit for the first time period.

27. The system of claim 22, the computing device further configured to analyze the first estimated credit score and the second estimated credit score to determine correlations with events.

28. The system of claim 27, wherein the events include at least one of a life style change, a change in purchasing power, or a change in risk.

29. The system of claim 27, wherein the at least one consumer includes thousands of consumers.

30. The system of claim 21, the computing device further configured to:
for a predetermined number of time periods, determine a set of attribute values for each of the predetermined number of time periods by applying a number of attributes to a subset of the trended data that represents the at least one consumer's profile for the predetermined number of time periods;
compute estimated credit scores based on the set of attribute values for each of the predetermined number of time periods; and
output the estimated credit scores for each of the predetermined number of time periods.
